(19) United States
(12) Patent Application Publication
(10) Pub. No.: US 2024/0388422 A1
(43) Pub. Date: Nov. 21, 2024

(54) GENERATING SHARED KEYS

(71) Applicant: nChain Licensing AG, Zug (CH)

(72) Inventor: Michaella PETTIT, London (GB)

(21) Appl. No.: 18/694,283

(22) PCT Filed: Sep. 26, 2022
(86) PCT No.: PCT/EP2022/076636

§ 371 Date: Mar. 21, 2024

(30) Foreign Application Priority Data
Oct. 26, 2021 (GB) 2115391.1

(51) Int. Cl. H04L 9/08; H04L 9/32

(52) U.S. Cl. CPC H04L 9/0838; H04L 9/085; H04L 9/3255

(57) ABSTRACT

A computer-implemented method of generating a shared key, comprising: each target participant: evaluating a respective function at the target index of that target participant to generate a respective first result, evaluating a respective function at the target index of each other target participant to generate a respective second result, sending the respective second result to the respective other target participants but not any of the dummy participants, obtaining a respective second result from each other target participant, generating a respective share of the shared key based on the respective first result and each of the obtained respective second results, evaluating the respective function at the respective dummy index of each respective dummy participant to generate a respective third result, sending the respective third result to the respective dummy participant; and each dummy participant generating a respective share of the shared key based on each of the obtained third results.

### CROSS REFERENCE TO RELATED APPLICATIONS

This application is the U.S. National Stage of International Application No. PCT/EP2022/076636 filed on Sep. 26, 2022, which claims the benefit of United Kingdom Patent Application No. 2115391.1, filed on Oct. 26, 2021, the contents of which are incorporated herein by reference in their entireties.

### TECHNICAL FIELD

The present disclosure relates to a method of generating a shared key, such as a shared private key or a shared ephemeral private key.

### BACKGROUND

Public-key cryptography is a type of cryptographic system that uses pairs of keys: private keys which are known only to the owner of the private key, and public keys which are generated based on the corresponding private key and which may be disseminated without compromising the security of the private key.

Public-key cryptography enables a sender to encrypt a message using a recipient's public key (i.e. the public key corresponding to a private key known only to the recipient). The encrypted message can then only be decrypted using the recipient's private key.

Similarly, a sender can use their own private key to sign a message, e.g. to prove that the message is being sent by the sender, and/or to indicate that the sender agrees with the message. The signer (i.e. the party generating the signature) uses their private key to create a digital signature based on the message. Creating a digital signature based on a message means supplying the message and private key to a function that generate the signature based on both the message and private key. The signature is added to (e.g. tagged onto) the message or otherwise associated with the message. Anyone with the signer's corresponding public key can use the same message and the digital signature on the message to verify whether the signature was validly created, i.e. whether the signature was indeed made using the signer's private key. As well as ensuring the authenticity of a message, digital signatures also ensure the integrity and non-repudiation of the message. That is, a digital signature can be used to prove that a message has not been changed since it was signed with the signature, and that the creator of a signature cannot deny in the future that they created the signature.

A digital signature scheme typically involves three procedures, i.e. algorithms. A key generation algorithm is used to generate a random private key and a corresponding public key. A signing algorithm is used to generate a signature based on a message and the private key. A verification algorithm is used to verify, given a public key and the message, whether the signature has been generated using the corresponding private key and according to the signing algorithm.

In general, a shared secret may be used to share a data item that is distributed amongst a group of participants. Each participant has a different share of the secret. Normally, the secret can only be reconstructed when a certain number (referred to as the “threshold”) of participants make their respective shares available, e.g. to be combined to calculate the secret. A common use of a shared secret is as a shared private key of a private-public key pair. That is, the private key may be distributed amongst a group of participants such that no single participant has access to the private key. Therefore no single participant can generate a valid signature of a message. Instead, some or all of the participants must together generate the private key in order for the signature to be generated.

Instead of the participants sharing their private key shares in order to generate a signature, they may instead use a threshold signature scheme. A threshold signature scheme allows a threshold number of participants in a group to create a digital signature based on a message using individual shares of a shares private key, without the private key being made available to any one participant. Here, a digital signature is a signature which is generated based on the message to be signed. In such a scheme, the signature can only be created if the threshold number of participants agree to generate the signature on the message. Any attempt to generate a signature using a smaller number of participants will not generate a valid signature. Therefore, a valid signature by the group (i.e. one generated using the message and the shared private key) provably had the threshold number of people agree to generate the signature. This also implies that any adversary needs to obtain the threshold number of shares of the private key to forge a signature with that private key.

### SUMMARY

A group of participants may use a secret sharing scheme, such as the joint verifiable secret sharing scheme (JVRSS), to establish a shared secret. As mentioned above, the shared secret may be used as part of a threshold signature scheme. Secret sharing schemes typically treat each participant as equals. That is, each participant performs the same actions to establish a share of the shared secret, and each participant learns (i.e. obtains) the same information, or at least the same type of information, if not the same specific value. For example, each participant learns a share of the shared secret, but each share will be different.

The present disclosure breaks with convention by recognising that not each participant need perform the same actions as part of a secret sharing scheme, and thus different participants may learn different amounts (or types) of information. In effect, two classes of participants are formed: target participants and dummy participants.

According to one aspect disclosed herein, there is provided a computer-implemented method of generating a shared key having a threshold, wherein a group of participants comprises a set of target participants and a set of dummy participants, wherein each target participant is associated with a respective target index and each dummy participant is associated with a respective dummy index, and wherein the method comprises:
each target participant evaluating a respective function at the respective target index of that target participant to generate a respective first result;
each target participant evaluating a respective function at the respective target index of each other target participant to generate a respective second result;
each target participant sending the respective second result to the respective other target participants but not any of the dummy participants, and obtaining a respective second result from each other target participant;
each target participant generating a respective share of the shared key based on the respective first result and each of the obtained respective second results;
each target participant evaluating the respective function at the respective dummy index of each respective dummy participant to generate a respective third result;
each target participant sending the respective third result to the respective dummy participant; and
each dummy participant generating a respective share of the shared key based on each of the obtained third results.

The present disclosure enables a set of target participants to collaborate with a set of dummy participants to compute a shared key (e.g. a shared private key or shared ephemeral private key) with a desired threshold. The present disclosure makes use of “dummy participants”. These are participants that generate a share of the shared key but do not learn enough information to be able to calculate the corresponding public key. This means that the dummy participants cannot link the process of taking part in the scheme to, for example, a signature generated using the shared key. This is advantageous from at least a privacy perspective. In addition, the dummy participants are required to perform fewer operations than the target participants, which is advantageous from a computational perspective. Specifically, only the target participants are required to evaluate the respective function using the participant indexes.

In some embodiments, the respective functions are defined by randomly generated coefficients. In these embodiments, the dummy participants are able to generate a respective share of the shared secret whilst avoiding a costly random number generation process.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 schematically illustrates an example system for generating a shared key, and

FIG. 2 shows an example method for generating a shared key.

### DETAILED DESCRIPTION OF EMBODIMENTS

### 1. Cryptographic Concepts

Whilst the following examples are described in terms of elliptic curve cryptography, the invention is not limited to any one particular cryptographic scheme and may in general be applied to any cryptographic scheme, e.g. RSA or other public key cryptography schemes.

### 1.1 Elliptic Curve Groups

An elliptic curve E satisfies the equation:

$${y}^{2} = {x}^{3} + ax + b mod p$$

where a, b ∈ [symbol] ₚ and a, b are constants satisfying 4a³+27b²≠0. The group over this elliptic curve is defined to be the set of elements (x, y) satisfying this equation along with the point at infinity [symbol] , which is the identity element. The group operation on the elements in this group is called elliptic curve point addition and denoted by +. This group is denoted by E ( [symbol] ₚ) and its order by n.

This group operation can be used to define another operation on the elements called point multiplication denoted by ·. For a point G ∈E( [symbol] ₚ) and a scalar k ∈ [symbol] ₙ^{&}, the point k·G is defined to be the point G added to itself k times.

In elliptic curve cryptography, a private key is defined to be a scalar k ∈ [symbol] ₙ\{0} where [symbol] ₙ\{0} is notation for the set {1, . . . , n−1}, and the corresponding public key is the point k·G on an elliptic curve. For instance, in some blockchain protocols, the elliptic curve is chosen to be the secp256k1 elliptic curve, and the values a, b, and p are completely specified by this curve. The order n of this group has been calculated given these values, which in the case of this curve is a prime, and the secp256k1 standard also specifies a point G which is to be used as the generator of this group.

### 1.2 Elliptic Curve Digital Signature Algorithm

In order to create a signature on a message msg, with the private key a, the following steps are taken:
1. Calculate the message digest e=hash(msg), where may be any hash function. For instance, in some examples hash(msg)=SHA256(SHA256(msg)) where SHA256( [symbol] ) is the SHA-256 hash function. Note that instead the message may be hashed only once, or more that two times with the same or different hash functions.
2. Chose a random integer k∈{1, . . . , n−1}, where n is the order of the elliptic curve, e.g. the secp256k1 curve. In the following, k is referred to as the ephemeral private key.
3. Calculate the ephemeral public key corresponding to this ephemeral private key k·G=(Rₓ, R_{y}).
4. Calculate r=Rₓ mod n. If r=0, return to step 2.
5. Calculate the multiplicative inverse of the ephemeral key k⁻¹ mod n.
6. Calculate s=k⁻¹(e+ar) mod n. If s=0, return to step 2.
7. The signature on the message msg is (r, s).

The ephemeral key must be kept secret, otherwise the private key can be calculated, given a message and signature. Additionally, each time a signature is generated, a different ephemeral key must be used. If this is not the case, it is possible to derive the private key a given two different signatures and their corresponding messages.

Given a message msg, a public key P=a·G, and corresponding signature (r, s), then one can verify the signature by completing the following steps:
1. Calculate the message digest e=hash(msg), e.g. e=SHA256(SHA256(msg)).
2. Calculate the multiplicative inverse s⁻¹ of s modulo n.
3. Calculate j₁=es⁻¹ mod n and j₂=rs⁻¹ mod n.
4. Calculate the point Q=j₁·G+j₂·P.
5. If Q= [symbol] , the point at infinity, the signature is invalid.

6. If Q≠ [symbol] , then let Q:=(Qₓ, Q_{y}), and calculate u=Qₓ mod n. If u=r, the signature is valid.

In threshold signature schemes, this private key a is split into key shares that are distributed amongst participants in a threshold scheme group.

### 1.3 Joint Verifiable Random Secret Sharing

Assume that N participants want to create a joint secret that can only be regenerated by at least (t+1) of the participants in the scheme. To create the shared secret, the following steps are taken:
1. The participants agree on the unique label i for each participant. Each participant i generates (t+1) random numbers

$${a}_{ij} {∈}_{R} {ℤ}_{n} \backslash \{ 0 \} , ∀ j = 0 , ... , t ,$$

where ∈_{R} means a randomly generated element of the set [symbol] ₙ\{0} where [symbol] ₙ\{0} is notation for the set {1, . . . , n−1}. Then each participant has a secret polynomial of order t

$${f}_{i} ( x ) = {a}_{i 0} + {a}_{i 1} x + … + {a}_{it} {x}^{t} mod n ,$$

for i=i=1, . . . , N. Note that we omit the mod n notation from now on, and it is assumed that all arithmetic operations over integers are done modulo n.
2. Each participant i sends the value fᵢ(j) to participant j e.g. using a secure communication channel with participant j only.
3. Each participant i calculates their own private secret share of a shared secret polynomial as

$${a}_{i} := {\sum }_{j = 1}^{N} {f}_{j} ( i ) .$$

A shared secret share is a point with the form (i, aᵢ), where i is the participants label in the scheme. This method for creating a secret share of a, as described in steps 1-3, is denoted herein by aᵢ=JVRSS(i) for participant i. Note that “JVRSS” typically stands for “Joint verification random secret sharing” and includes steps 4 and 5 as well. However, throughout this document JVRSS is taken to mean performing at least steps 1 to 3, where steps 4 and 5 are optional steps.

Now that the participants have generated a shared polynomial, they can each verify that the other participants have shared the correct information to all participants, and that all participants have the same shared polynomial. This is done in the following way.
4. Each participant i broadcasts to all participants the obfuscated coefficients

aᵢₖ·G
for k−0, . . . , t.
5. Each participant i checks that each participant j has correctly calculated the polynomial point fⱼ(i) by calculating fⱼ(i)·G and verifying that

$${f}_{j} ( i ) \cdot G {=}^{?} {\sum }_{k = 0}^{t} {i}^{k} ( {a}_{jk} \cdot G ) ∀ j = 1 , ... , N .$$

If all participants find that this equation holds for each polynomial, then the group can collectively be sure that they have all created the same shared polynomial.

### 1.4 Reconstructing a Shared Secret

Assume a participant wants to reconstruct a shared secret a which is the zeroth order of a shared polynomial. Given (t+1) points on this polynomial of the form

$$( 1 , {a}_{1} ) , ... , ( ( t + 1 ) , {a}_{t + 1} ) ,$$

then to find the shared secret a, one calculates

$$interpolate ( {a}_{1} , ... , {a}_{t + 1} ) = ( {\sum }_{l = 1}^{t + 1} {a}_{l} {\prod }_{\begin{matrix}1 \leq j \leq ( t + 1 ) , \\ j \neq l\end{matrix}} ( - j ) {( l - j )}^{- 1} ) = a ,$$

which is derived from a general formula known as “Lagrange Interpolation”.

### 1.5 Public Key Calculation

Given the N zeroth-order private polynomial coefficient public keys aᵢ₀·G for i=1, . . . , N shared in step 4 of JVRSS, each participant calculates the shared public key P using

$$P = a \cdot G = {\sum }_{j = 1}^{N} {a}_{j 0} \cdot G ,$$

corresponding to the shared secret a.

### 1.6 Addition of Shared Secrets

To calculate the addition of two shared secrets that are shared amongst a group of N participants, where each secret polynomial has order t, without any entity knowing the individual secrets, the following steps are taken:
1. Generate the first shared secret a, where participant i's share is given by aᵢ=JVRSS(i) for i=1, . . . , N with a threshold of (t+1).
2. Generate the second shared secret b, where participant i's share is given by bᵢ=JVRSS(i), with a threshold of (t+1).
3. Each participant i calculates their own additive share

$${v}_{i} = {a}_{i} + {b}_{i} mod n .$$

4. All participants broadcast their additive share vᵢ to all other participants.
5. Each participant interpolates over at least (t+1) of the shares vᵢ to calculate

$$v = interpolate ( {v}_{1} , ... , {v}_{t + 1} ) = a + b .$$

This method for the addition of shared secrets is denoted by ADDSS(i) for participant i, which results in each participant i knowing v=(a+b).

### 1.7 Product of Shared Secrets

To calculate the product of two shared secrets that are both shared amongst a group of N participants, where each secret polynomial has order t, the group takes the following steps:
1. Generate the first shared secret a, where participant i's share is given by aᵢ=JVRSS(i) for i=1, . . . , N. The shared secret polynomial has order t, meaning (t+1) participants are required to recreate it.
2. Generate the second shared secret b, where participant i's share is given by bᵢ=JVRSS(i), and the shared secret polynomial again has order t.
3. Each participant calculates their own multiplicative share μᵢ using

μᵢ=aᵢbᵢ
4. All participants broadcast their multiplicative share μᵢ to all other participants.
5. Each participant interpolates over at least (2t+1) of the shares μᵢ at 0 to calculate

$$μ = interpolate ( {μ}_{1} , ... , {μ}_{2 t + 1} ) = ab .$$

This method for calculating the product of two shared secrets is denoted herein by μ=ab=PROSS(i) for participant i.

### 1.8 Inverse of a Shared Secret

In order to calculate the inverse of a shared secret a, the following steps are taken:
1. All participants calculate the product of shared secrets PROSS(i), the result of which is μ=ab mod n.
2. Each participant calculates the modular inverse of μ which results in

$${μ}^{- 1} = {( ab )}^{- 1} mod n .$$

3. Each participant i calculates their own inverse secret share by calculating

$${a}_{i}^{- 1} = {μ}^{- 1} {b}_{i} .$$

This method for calculating the inverse of shared secrets is denoted by aᵢ⁻¹=INVSS(i) for participant i.

### 1.9 Shared Private Key Generation and Verification

To calculate a shared private key a between N≥2t+1 participants, t+1 of which are required to create a signature, the participants execute JVRSS with a threshold of t+1 and public key calculation as described above. The result is that every participant i=1, . . . , N has a private key share aᵢ and the corresponding shared public key P=(a·G).

### 1.10 Ephemeral Key Shares Generation

To generate ephemeral key shares and the corresponding r, as is required in a signature, a group of size N with a shared private key a of threshold (t+1) execute the following steps:
1. Generate the inverse share of a shared secret kᵢ⁻¹INVSS(i), where (t+1) shares are required to recreate it.
2. Each participant calculates

$$( x , y ) = {\sum }_{i = 1}^{N} ( {k}_{i 0} \cdot G ) ,$$

using the obfuscated coefficients shared in the verification of kᵢ, then they calculate

r=x mod n
3. Each participant i stores (r, kᵢ⁻¹).
   1.11 Addition of Secrets with Different Thresholds

In the case of addition of secrets of order t and t′, the addition of the two secrets requires max (t, t′)+1 number of shares to calculate it. The reason behind this is that the addition step of the shares of the shared secrets creates a share of a new polynomial. This new additive polynomial is equivalent to the result of the addition of the individual polynomials of the two shared secrets. Adding two polynomials is adding the corresponding coefficients at each order of x. Therefore, the order of the additive polynomial must be the same order as the highest order of the two polynomials. This can be generalised to the addition of more than two polynomials, where the order of the resulting polynomial is the same as the order of the highest order individual polynomial.

Once the addition of two secrets with different thresholds has been calculated, the security of the higher threshold secret is reduced. This is because if one now knows the result (a+b) with respective thresholds t, t′ and assume that t<t′, then one can calculate a with t shares, and then calculate (a+b)−a=b, and so the value b has been calculated with only t shares. This lower threshold is referred to below as the ‘implicated threshold’ of b.

1.12 Multiplication of Secrets with Different Thresholds

In the case of multiplication of two secrets with a threshold of t and t′, the calculation of the multiplication requires t+t′+1 shares. In this case, the multiplication of shares of two polynomials results in a share on a new polynomial. This new polynomial is the result of multiplying the two individual polynomials and so the order of the result is the addition of the order of the two individual polynomials.

Multiplication can also be generalised to any number of shared secrets, with the resulting threshold being the sum of the individual thresholds plus 1, Σ_{ρ}t_{ρ}+1, where ρ runs over the individual shared secrets.

Similar to addition, the multiplication of two secrets with different thresholds results in an implicated threshold of the higher threshold secret. As before, if ab is known where a has a threshold of t and b has a threshold of t′, and t<t′, then both a and b can be calculated with t shares. First, one can calculate a and using (ab)a⁻¹ find b with only t shares of a secret.

### 1.13 Combining the Addition and Multiplication of Shared Secrets in One Step

It is possible to generalise the above to calculate any combination of addition and multiplication in one step. Assume a group of N participants want to calculate the result ab+c, where a, b, c are shared secrets with thresholds (tₐ+1), (t_{b}+1), (t_{c}+1) respectively. There is a condition which is max (tₐ+t_{b}, t_{c})<N, that is, the number of participants of the scheme must be greater than the maximum between the order of the secret c and the order of the result of the multiplication of the secrets a and b.
1. Each participant i calculates their secret shares aᵢ=JVRSS(i), bᵢ=JVRSS(i), cᵢ=JVRSS(i) with thresholds (tₐ+1), (t_{b}+1), (t_{c}+1) respectively.
2. Each participant i calculates the share λᵢ=aᵢbᵢ+cᵢ.
3. Each participant i shares the result λᵢ with the other participants.
4. Each participant interpolates over max(tₐ+t_{b}, t_{c})+1 shares to find the result λ=int(λ₁, . . . , λᵢ, . . . )=ab+c.

This is done in the calculation of a shared signature according to some embodiments below. That is, there is an interpolation over sᵢ=kᵢ⁻¹(e+aᵢr). This is essentially the case above with aᵢbᵢ=kᵢ⁻¹ aᵢr and cᵢ=kᵢ⁻¹e. In this case tₐ+t_{b}=2t and t_{c}=t, and interpolation is over max(tₐ+t_{b}, t_{c})+1=2t+1 shares.

### 2. Generating a Shared Key

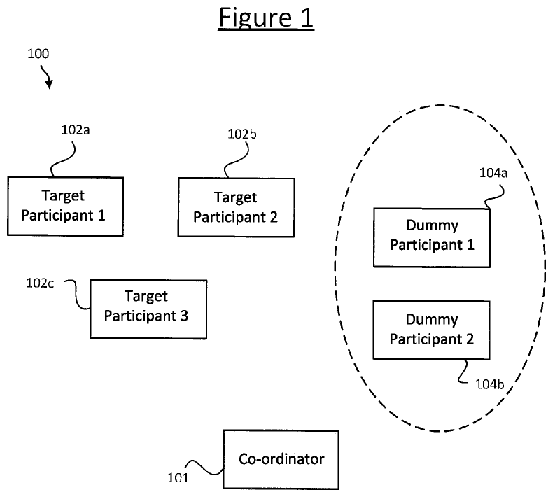

FIG. 1 illustrates an example system 100 for generating a shared key. As shown, the system 100 comprises a plurality (i.e. group) of participants (e.g. users, machines, etc.) 102, 104. The group of participants is made up of two distinct sets of participants: a set of target participants 102b and a set of dummy participants (or “observers”) 104. The terms “target participants” and “dummy participants” could be replaced with “first participants” and “second participants”. That is, the terms are merely labels for the two sets of participants. A participant may also be referred to as a party or an entity. Each of the participants 102, 104 operates respective computing equipment.

Each of the respective computing equipment of the respective participants 102, 104 comprises respective processing apparatus comprising one or more processors, e.g. one or more central processing units (CPUs), accelerator processors (GPUs), application specific processors and/or field programmable gate arrays (FPGAs). The respective computing equipment may also comprise memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The respective computing equipment may comprise at least one user terminal, e.g. a desktop or laptop computer, a tablet, a smartphone, or a wearable device such as a smartwatch. Alternatively or additionally, the respective computing equipment may comprise one or more other networked resources, such as cloud computing resources accessed via the user terminal (the cloud computing resources comprising resources of one or more physical server devices implemented at one or more sites). It will be appreciated that any act described as being performed by a party of the system 100 may be performed by the respective computing apparatus operated by that party.

Each of the participants 102, 104 are configured to transmit data to one, some or all of the other participants 102, 104 over the internet using a LAN or WAN connection, or via alternative wired or wireless communication means. Unless the context requires otherwise, reference to a participant 102 transmitting data may be understood as transmitting data to other participants 102 individually, e.g. via a secure communication channel between two participants, or broadcasting to the group as a whole, e.g. via email or other means. Again, unless the context requires otherwise, each participant 102, 104 may transmit data in raw form, or in obfuscated form. For instance, the data may be encrypted using a public key of a recipient participant before being send to that recipient participant.

In FIG. 1, the set of target participants contains three participants 102a, 102b, 102c, and the set of dummy participants contains two participants 104a, 104b (shown enclosed by a dotted circle). It will be appreciated that this is just for illustrative purposes, and in general each set may contain any number of participants. Note that unless the context requires otherwise, “first”, “second”, and so on are used merely as distinguishing labels, and do not necessarily imply an order, hierarchy, or the like.

Embodiments of the present disclosure enable each of the participants 102, 104, both target and dummy, to generate a respective share of a shared private key (or more generally, a shared key). The shared private key is a number, such as a 256-bit integer. Similarly, any key referred to below is also a number. The shared private key has a threshold. For example, the shared private key may have a threshold of t+1.

Each participant 102, 104 is associated with a respective index (i.e. a number). The index of a target participant will be referred to as a target index. The index of a dummy participant will be referred to as a dummy index. Each index is unique to a given participant, i.e. no participant has the same index. The indexes may be consecutive, e.g. 1, 2, 3, 4, etc. The indexes may be assigned by a coordinating party 101, or by one of the participants 102, 104.

To generate the shared key, each target participant 102 begins by obtaining (e.g. generating) a respective function. The functions are private in the sense that the target participants 102 do not reveal the functions to other participants 102, 104. The function may be a polynomial. In some examples, the function is generated as described in step 1 of the Joint Verifiable Random Secret Sharing (JVRSS) scheme described above (see section 1.3). However this is just one example, and other functions may be used. If a polynomial of this kind is used, the function may be generated by generating a set of coefficients of the polynomial. The coefficients may be random numbers. That is, each target participant 102 may generate a set of random numbers to be used a coefficients of a respective polynomial function.

Each target participant 102 evaluates the respective function at the respective target index of each target participant 102 to generate a respective result. This includes each target participant 102 evaluating the respective function using its own target index, and also evaluating the respective function using the respective target index of each other target participant 102. The result generating using a target participant's own index will be referred to as a first result. The results generated using other target participant's indexes will be referred to as second results. Therefore each target participant will generate a respective first result and one or more respective second results.

Each second result generated by a given target participant 102 will be different because each participant has a different index. Similarly, different target participants 102 will generate different second results for the same other target participant because each target participant 102 uses a different function.

Each target participant 102 shares the respective second results with the respective target participants 102 whose index was used to generate the respective second result. For example, the first target participant 102a may generate a second result for the second target participant using and send that second result to the second target participant 102b. Similarly, the first target participant 102 may generate a second result for the third target participant 102c using and send that second result to the third target participant 102c. The second participant 102b and third participant 102c perform equivalent actions.

The target participants 102 keep their respective first results to themselves, i.e. the first results are kept private. The target participants 102 only share the second results with the target participants whose index was used to generate the respective second result. Neither the first results nor the second results are shared with the dummy participants 104.

As an example, a first target participant 102 may generating a first private key share a₁ by generating a set of numbers a₁ⱼ∈_{R} [symbol] ₙ\{0}, ∀j=0, . . . , t, and then generating a first polynomial f₁(x)=a₁₀+a₁₁x+. . . +a₁ₜx^{t} mod n, where the set of numbers are the coefficients of the polynomial. Each of the other target participants 102 may generate a respective polynomial using a respective set of numbers. For instance, the second target participant 102b generates a second polynomial f₂(x)=a₂₀+a₂₁x+. . . +a₂₁x^{t} mod n.

The participants 102, 104 then transmit to each other participant 102, 104, a value of their respective function evaluated at the index of that other participant 102. For instance, the first participant 102a evaluates f₁(2) for the second participant 102b and then transmits that value to the second participant 102b, evaluates f₁(3) for the third participant 102c and then transmits that value to the third participant 102c, and so on. The first participant 102a obtains the respective values generated, as a function of the first participant's index, by the other participants 102. The values may be transmitted over the internet, or via other means. The values may be transmitted via respective secure communication channels between respective pairs of the participants. Instead of transmitting directly, one or more participants 102 (e.g. the first participant 102a) may broadcast their respective values.

Each target participant 102 will have obtained a respective first result and one or more respective second results (the first result having been generated and the second results having been received). Each target participant 102 generates a respective share of the shared key using the obtained results. That is, each target participant 102 generates a respective key share based on (i.e. as a function of) the respective first result and the one or more respective second results.

Each target participant 102 also evaluates the respective function at the respective dummy index of each dummy participant 104 to generate a respective result. This result will be referred to as a third result. Each target participant 102 shares the respective third results with the respective dummy participants 104 whose index was used to generate the respective third result.

Each dummy participant 104 therefore obtains one or more third results, one from each target participant 102. Each dummy participant 104 generates a respective share of the shared key using the obtained results. That is, each dummy participant 104 generates a respective key share based on (i.e. as a function of) the respective third results.

Each participant, both target participants 102 and dummy participants 104, therefore have a share of the same shared key. The key shares may be used for e.g. threshold encryption or threshold signatures. For example, one or more participants 102, 104 may generate a respective signature share based on their respective key share and a message, or a hash thereof. Or, one or more participants 102, 104 may encrypt a message using their respective keys share.

The described method may be used to generate multiple shared keys, e.g. a shared private key and a shared ephemeral private key.

An advantage of the described embodiments is that the dummy participants are not able to calculate the public key corresponding to the shared key. In conventional secret sharing schemes, such as JVRSS, the participants that generate shares of the shared key are able to calculate the public key. This means that any participant can tell, for example, that a signature has been generated with the shared key. In contrast, the present scheme enables only the target participants 102 to calculate the public key.

The target participants 102 may generate the public key corresponding to the shared key (call it a “shared public key”). For example, the shared public key may be generated using the public key calculation described above in section 1.5.

In some examples, the dummy participants 104 generate a public key corresponding to their respective key share (not the shared key itself). The dummy participants 104 send the public key, call it a “public key share”, to one or more of the target participants 102. This allows the target participant(s) 102 to verify that the dummy participants 104 have correctly calculated their share of the shared key.

In examples where the respective function used to generate the results is a polynomial defined by a respective set of coefficients, each target participant 102 may obfuscate each coefficient with a public key generator point to obtain a set of obfuscated coefficients. The obfuscated coefficients may be shared amongst the target participants 102. For a dummy participant 104 with a respective dummy index, a target participant 102 may verify the respective public key share based on the set of obfuscated coefficients and the respective dummy index. For instance, the public key share may be required to be equal to the multiplication of the dummy index and the set of obfuscated coefficients.

As shown in FIG. 1, the system 100 may also comprise a coordinator 101. The coordinator may be one of the target participants, e.g. the first target participant 102a. Alternatively, the coordinator 101 may be a separate entity. The coordinator operates respective computer equipment as described above with reference to the participants 102, 104. The coordinator 101 may have the role of constructing a signature using a threshold number of signature shares generated by respective target participants 102 using shares of the shared key. That is, the coordinator 101 may generate a signature on (i.e. for) a message to be signed. Generating a signature on a message is taken to mean that a signature is dependent on the message to be signed, or put another way, the signature is a function of the message to be signed. The coordinator 101 may also be the party that sends the signature, and optionally the message, to a third party 103 or otherwise outputs the signature. For instance, the third party 103 may be a certificate authority or other form of authority, or another user. In other examples, the signature may be recorded, e.g. in a database or other document. In some examples, the signature may be made available to the public, e.g. recorded on a website or other publicly accessible medium, such as a blockchain.

The coordinator 101 may transmit a message to be signed to the participants 102, 104. The message may be transmitted to all of the participants 102, 104 or to a subset of the participants, e.g. the threshold number of participants. The coordinator 101 may transmit the message to one participant who then forwards the message to one, some or all of the other participants 102, 104. The message may be transmitted over the internet using a LAN or WAN connection, or via alternative wired or wireless communication means. The message may be transmitted to each participant 102, 104 individually, e.g. via a secure communication channel between the coordinator 101 and each participant 102, 104, or broadcast to the group of participants as a whole, e.g. via email or other means. The message may be transmitted in raw form, or in encrypted form. For instance, the message may be hashed one or more times.

One or more of the participants 102, 104 may obtain the message via alternative means, i.e. not from the coordinator 101. For example, the message may be generated by one of the target participants 102, or may already be available, e.g. publicly. One or more participants 102, 104 may receive the message from a third party 103. A participant 102, 104 that obtains the message may transmit the message (in raw or encrypted form) to one or more other participants 102, 104. For instance, the first target participant 102 may transmit the message to the other participants.

Each participant 102, 104 (or at least the threshold number) may generate a respective signature share using at least their respective key share and the message, and make the signature share available to the coordinator 101 for constructing the signature.

The coordinator 101 may then broadcast or transmit the signature to one or more other entities. Additionally or alternatively, the coordinator may store the signature, and/or record the signature as part of a digital record, e.g. in an email or other document. For example, the message may be part or all of a blockchain transaction. The signature may be included in that blockchain transaction (if the message is only part of the blockchain transaction), or in a different blockchain transaction.

In general, embodiments of the present disclosure may be used to generate a signature on (i.e. for) any message. As a particular example use case, the message may be part or all of a blockchain transaction. That is, the signature may be used to sign one or more inputs and/or one or more outputs of a blockchain transaction. For instance, the generated signature may be used, at least in part, to unlock an output of a blockchain transaction. As a particular example, the output of a previous transaction may be a pay-to-public-key-hash (P2PKH) output which is locked to a hash of a public key. In order to be unlocked, an input of a later transaction that references the P2PKH output needs to include the (unhashed) public key and a signature generated based on the private key corresponding to the public key.

Represented in script, the “locking script” and “unlocking script” may take the following forms:
Locking script=OP_DUP OP_HASH160<Public KeyHash>OP_EQUAL OP_CHECKSIG Unlocking script=<Signature><Public Key>

Referring to the above-described embodiments, the <Public Key>may be equated to P=a·G, and the <Signature> comprises the threshold signature s, where the previous transaction is the message to be signed. Note that as stated above, ECDSA signatures are in the form (r, s).

Note that the described signature generation method is not limited to any particular use case and may in general be used for generating a signature based on any message. Signing all or part of a blockchain transaction is just one illustrative example. The described method may be used to sign and/or authorise, for instance, a legal document (e.g. a will, deed or other contract), correspondence between one or more parties, digital certificates (e.g. issued by a certificate authority), medical prescriptions, a bank transfer or a financial instrument, a mortgage or loan applications, etc.

As a particular example, the group of participants (say five participants in total) may form the Board of a company. Voting matters of the company may require a majority of the Board (i.e. at least three participants) to agree on the particular vote. The Board may use the described signature generation method to prove that at least three Board members agreed to vote in favour of a particular outcome. In this example, the threshold of the signature generation scheme is three. That is, at least three of the Board members must provide a respective signature share in order for the co-ordinator to successfully generate a signature. If a signature is generated successfully, at least the threshold number (i.e. three) of Board members must have agreed to vote in favour of that outcome. Thus the successful generation of a signature acts as a record of the vote and proves that a majority of the Board voted in a particular way.

Another use case for the present invention lays in the field of digital certificates, e.g. digital certificate issued by the X·509 standard. A digital certificate contains a signature that signs over some data. The data can in general be any data, but one particular example of data included in a digital certificate is a public key. A public key in a digital certificate is often referred to as a “certified public key”. The issuer of the digital certificate (a “certificate authority”) may perform one or more checks on the owner of the public key (e.g. know-your-customer checks), and if the checks are successful, the certificate authority issues a digital certificate that includes the certified public key. A user can use a certified public key to prove they are who they say they are, e.g. by signing a message with a private key corresponding to the certified public key.

One particular use for certificate authorities is to sign certificates used in HTTPS for secure browsing on the internet. Another common use is in issuing identity cards by national governments for use in electronically signing documents. The certificate authority signs the public key (or any other data to be attested to) using a private key.

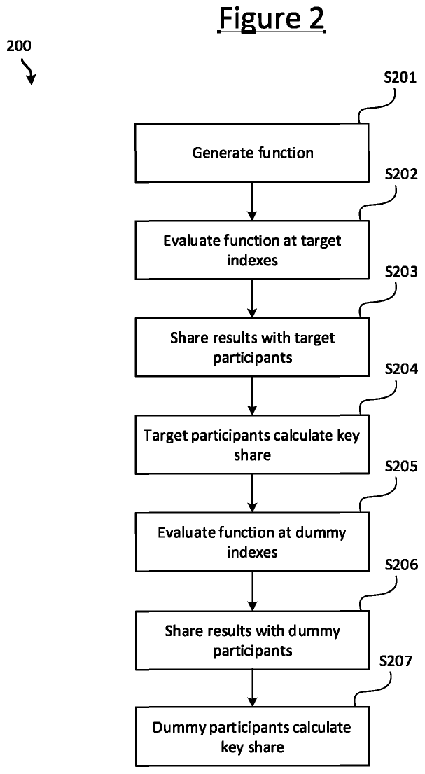

FIG. 2 shows a flow chart illustrating an example method 200 for generating a shared key according to the described embodiments. The method 200 may be begin, at step S201, with each target participant 102 generating a function (e.g. a polynomial). Then, at step, S202, the function is evaluated at each target index. At step S203, the results are shared with the target participants 102. At step S204, the target participants 102 generate a key share. At step S205, the function is evaluated at each dummy index. Then, at step S206, the results are shared with the dummy participants 104. At step S207, the dummy participants 104 generate a key share.

### 3. Observer JVRSS

Embodiments of the present disclosure may be used to modify JVRSS to restrict the generation of the shared public key to only participants of the scheme, i.e. the target participants 102. This has the benefit of reducing the number of random number generations, which improves efficiency. This can also be used to keep the public information secret from the dummy participants 104 such that they cannot identify which scheme they were a part of.

This modified JVRSS scheme will be referred to herein as ‘Observer JVRSS’ or O-JVRSS as the participants which do not generate any contribution to the shared secret may be seen as ‘observers’. The information that reveals the public key to the dummy participants is kept hidden from them. To create a group of participants in a threshold group who will not have knowledge of the shared public key P corresponding to a shared private key a, the group do the following. Scheme participants is another term for the target participants.
1. All scheme participants i execute steps 1-3 in JVRSS without verification steps at this point. Each scheme participant has a private polynomial and has given the share on the private polynomial to each other scheme participant who calculated their own share. Dummy participants do not take part in this step.
2. Each scheme participant j sends the value on their secret polynomial fⱼ(i) to participant i in the dummy participant group. The dummy participants do not create their own secret polynomials and only receive shares of others.
3. The dummy participants calculate their private share aᵢ=Σⱼfⱼ(i).
4. The dummy participants calculate the public key corresponding to aᵢ·G and broadcasts this to the scheme participants.
5. Each scheme participant i verify that this public key corresponding to participant j's share corresponds to the sum of the obfuscated coefficients

$${a}_{j} \cdot G = {\sum }_{l} {\sum }_{k} {( j )}^{k} ( {a}_{lk} \cdot G ) .$$

The reason for the scheme participants to calculate this instead of the dummy participants as in the usual JVRSS is so that the dummy participants do not learn the corresponding public key connected with the share, while ensuring that the scheme is still secure. The public key can be publicly known, but the dummy participants will not be able to identity the link between their share and the public key unless it is explicitly stated.

Now the dummy participants all have shares a; corresponding to the shared private key. The same steps can also be done for the ephemeral key k, as the public key will correspond to r in any signature, creating an identifier. One or more blinding shares can be created with normal JVRSS as they do not have any corresponding public key information that is shared.

We label the steps 2-5by aᵢ=O-JVRSS(i) for dummy participant i, where the O stands for ‘observer’. If O-JVRSS is executed for the shared private key and ephemeral private key, any dummy participants will be able to contribute to higher threshold calculations, e.g. generating a threshold signature, without ever learning anything about which scheme they are taking part in.

### 4. Further Remarks

It will be appreciated that the above embodiments have been described by way of example only. More generally there may be provided a method, apparatus or program in accordance with any one or more of the following Statements.

Statement 1. A computer-implemented method of generating a shared key having a threshold, wherein a group of participants comprises a set of target participants and a set of dummy participants, wherein each target participant is associated with a respective target index and each dummy participant is associated with a respective dummy index, and wherein the method comprises:
each target participant evaluating a respective function at the respective target index of that target participant to generate a respective first result;
each target participant evaluating a respective function at the respective target index of each other target participant to generate a respective second result;
each target participant sending the respective second result to the respective other target participants but not any of the dummy participants, and obtaining a respective second result from each other target participant;
each target participant generating a respective share of the shared key based on the respective first result and each of the obtained respective second results;
each target participant evaluating the respective function at the respective dummy index of each respective dummy participant to generate a respective third result;
each target participant sending the respective third result to the respective dummy participant; and
each dummy participant generating a respective share of the shared key based on each of the obtained third results.

Statement 2. The method of statement 1, wherein the shared key is a shared private key.

Statement 3. The method of statement 2, comprising at least a threshold number of the group of participants generating respective shares of a threshold signature based on the respective share of the shared key and a message.

Statement 4. The method of statement 3, comprising:
at least the threshold number of the group of participants making their respective share of the threshold signature available to a coordinating party for generating the threshold signature.

Statement 5. The method of statement 4, comprising:
the coordinating party generating the threshold signature based on at least the threshold number of respective shares of the threshold signature.

Statement 6. The method of any preceding statement, wherein a total number of target participants is less than the threshold of the shared private key.

Statement 7. The method of any preceding statement, comprising:
each dummy participant generating a respective public key corresponding to the respective share of the shared private key and sending the respective public key to at least one target participant.

Statement 8. The method of any preceding statement, comprising:
each target participant generating a respective set of coefficients, wherein the respective function is a polynomial based on the respective set of coefficients.

Statement 9. The method of statement 7 and statement 8, comprising:
the at least one target participant obfuscating each of the respective set of coefficients with a public key generator point; and
the at least one target participant using the respective set of obfuscated coefficients to verify one of more of the respective public keys received from the respective dummy participant.

Statement 10. The method of statement 8 or statement 9, comprising:
each target participant generating a respective public key corresponding to a respective zeroth order coefficient of the polynomial and sending the respective public key to each other target participant; and
each target participant generating a public key corresponding to the shared key based on each of the respective public keys corresponding to the respective zeroth order coefficients.

Statement 11. The method of statement 8 or any statement dependent thereon, wherein the respective set of coefficients are randomly generated by the respective target participant.

Statement 12. The method of statement 3 or any statement dependent thereon, wherein the message comprises at least part of a blockchain transaction.

Statement 13. The method of statement 5 and statement 12, comprising:
the coordinating party adding the threshold signature to the blockchain transaction; and
submitting the blockchain transaction one or more nodes of a blockchain network.

Statement 14. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 15. A computer program embodied on computer-readable storage and configured so as, when run on computer equipment, to perform the method of any of statement 1 to 13.

According to another aspect disclosed herein, there may be provided a method comprising the actions of each target participant.

According to another aspect disclosed herein, there may be provided a system comprising the computer equipment of each target participant.

According to another aspect disclosed herein, there may be provided a method comprising the actions of each target participant and each dummy participant.

According to another aspect disclosed herein, there may be provided a system comprising the computer equipment of each participant target participant and each dummy participant.

Other variants or use cases of the disclosed techniques may become apparent to the person skilled in the art once given the disclosure herein. The scope of the disclosure is not limited by the described embodiments but only by the accompanying claims.

1. A computer-implemented method of generating a shared key having a threshold, wherein a group of participants comprises a set of target participants and a set of dummy participants, wherein each target participant is associated with a respective target index and each dummy participant is associated with a respective dummy index, and wherein the method comprises:
each target participant evaluating a respective function at the respective target index of that target participant to generate a respective first result;
each target participant evaluating a respective function at the respective target index of each other target participant to generate a respective second result;
each target participant sending the respective second result to the respective other target participants but not any of the dummy participants, and obtaining a respective second result from each other target participant;
each target participant generating a respective share of the shared key based on the respective first result and each of the obtained respective second results;
each target participant evaluating the respective function at the respective dummy index of each respective dummy participant to generate a respective third result;
each target participant sending the respective third result to the respective dummy participant; and
each dummy participant generating a respective share of the shared key based on each of the obtained third results.

2. The method of claim 1, wherein the shared key is a shared private key.

3. The method of claim 2, comprising at least a threshold number of the group of participants generating respective shares of a threshold signature based on the respective share of the shared key and a message.

4. The method of claim 3, comprising:
at least the threshold number of the group of participants making their respective share of the threshold signature available to a coordinating party for generating the threshold signature.

5. The method of claim 4, comprising:
the coordinating party generating the threshold signature based on at least the threshold number of respective shares of the threshold signature.

6. The method of claim 2, wherein a total number of target participants is less than the threshold of the shared private key.

7. The method of claim 2, comprising:
each dummy participant generating a respective public key corresponding to the respective share of the shared private key and sending the respective public key to at least one target participant.

8. The method of claim 1, comprising:
each target participant generating a respective set of coefficients, wherein the respective function is a polynomial based on the respective set of coefficients.

9. The method of claim 7, comprising:
each target participant generating a respective set of coefficients, wherein the respective function is a polynomial based on the respective set of coefficients;
the at least one target participant obfuscating each of the respective set of coefficients with a public key generator point; and
the at least one target participant using the respective set of obfuscated coefficients to verify one of more of the respective public keys received from the respective dummy participant.

10. The method of claim 8, comprising:
each target participant generating a respective public key corresponding to a respective zeroth order coefficient of the polynomial and sending the respective public key to each other target participant; and
each target participant generating a public key corresponding to the shared key based on each of the respective public keys corresponding to the respective zeroth order coefficients.

11. The method of claim 8, wherein the respective set of coefficients are randomly generated by the respective target participant.

12. The method of claim 3, wherein the message comprises at least part of a blockchain transaction.

13. The method of claim 5, wherein the message comprises at least part of a blockchain transaction, and wherein the method comprises:
the coordinating party adding the threshold signature to the blockchain transaction; and
submitting the blockchain transaction one or more nodes of a blockchain network.

14. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a shared key having a threshold, wherein a group of participants comprises a set of target participants and a set of dummy participants, wherein each target participant is associated with a respective target index and each dummy participant is associated with a respective dummy index, and wherein the method comprises:
each target participant evaluating a respective function at the respective target index of that target participant to generate a respective first result;
each target participant evaluating a respective function at the respective target index of each other target participant to generate a respective second result;
each target participant sending the respective second result to the respective other target participants but not any of the dummy participants, and obtaining a respective second result from each other target participant:
each target participant generating a respective share of the shared key based on the respective first result and each of the obtained respective second results;
each target participant evaluating the respective function at the respective dummy index of each respective dummy participant to generate a respective third result;
each target participant sending the respective third result to the respective dummy participant; and
each dummy participant generating a respective share of the shared key based on each of the obtained third results.

15. A computer program embodied on non-transitory computer-readable storage media and configured so as, when run on computer equipment, the computer equipment performs a method of generating a shared key having a threshold, wherein a group of participants comprises a set of target participants and a set of dummy participants, wherein each target participant is associated with a respective target index and each dummy participant is associated with a respective dummy index, and wherein the method comprises:
each target participant evaluating a respective function at the respective target index of that target participant to generate a respective first result;
each target participant evaluating a respective function at the respective target index of each other target participant to generate a respective second result;
each target participant sending the respective second result to the respective other target participants but not any of the dummy participants, and obtaining a respective second result from each other target participant;
each target participant generating a respective share of the shared key based on the respective first result and each of the obtained respective second results;
each target participant evaluating the respective function at the respective dummy index of each respective dummy participant to generate a respective third result;
each target participant sending the respective third result to the respective dummy participant; and
each dummy participant generating a respective share of the shared key based on each of the obtained third results.
